(19) United States
(12) Patent Application Publication
(10) Pub. No.: US 2014/0042815 A1
(43) Pub. Date: Feb. 13, 2014

(54) BALANCING, FILTERING AND/OR CONTROLLING SERIES-CONNECTED CELLS

(71) Applicant: The Regents of the University of Colorado, a body corporate, (US)

(72) Inventors: Dragan Maksimovic, Boulder, CO (US); Carlos Olalla, Boulder, CO (US)

(21) Appl. No.: 13/842,943

(22) Filed: Mar. 15, 2013

Related U.S. Application Data
(60) Provisional application No. 61/657,870, filed on Jun. 10, 2012.
(60) Provisional application No. 61/785,196, filed on Mar. 14, 2013.

(51) Int. Cl. H02J 1/00

(52) U.S. Cl. CPC H02J 1/00
USPC 307/63

(57) ABSTRACT

A balancing circuit for a plurality of series connected cells or substrings of cells is provided. In one implementation, the balancing circuit includes a plurality of primary ports; an isolated secondary port; and one or more DC-DC converters connected between the primary ports and the isolated secondary port. Each DC-DC converter includes at least one power switch. The DC-DC converters are configured to adjust a primary port current received at one or more of the plurality of primary ports based upon a difference between a voltage at the one of the primary ports and a reference voltage. Also provided are an electrical power system including such as balancing circuit and a method of balancing a plurality of electric cell substrings using such a balancing circuit.

### CROSS-REFERENCE TO RELATED APPLICATIONS

This application claims the benefit of (1) U.S. provisional application No. 61/657,870 entitled “Balancing, Filtering, and/or Controlling Series Connected Cells” and filed on Jun. 10, 2012 (the '870 application), and (2) U.S. provisional application No. 61/785,196 entitled “Balancing, Filtering and/or Controlling Series-Connected Cells” and filed on Mar. 14, 2013 (the '196 application). Both the '870 and '196 application are hereby incorporated by reference in their entirety as though fully set forth herein.

### GOVERNMENT LICENSE RIGHTS

This invention was made with government support under grant number DE-AR0000216 awarded by the U.S. Department of Energy. The government has certain rights in the invention.

### BACKGROUND

a. Field

The instant invention relates to systems, methods and components for balancing, filtering and/or controlling series connected electrical cells.

b. Background

Electrical power systems such as photovoltaic (PV) power systems or energy-storage (battery) systems (BS) commonly comprise a large number of cells connected in series. The series connection implies that the system performance, such as energy capture in PV systems or energy storage capacity in battery systems, is constrained by the performance of the weakest cell. As a result, the electrical power systems based on series-connected cells are adversely affected by any mismatches among the cells. Example balancing circuits and control methods are provided based on isolated DC-DC converters processing only a mismatch fraction of power.

### BRIEF SUMMARY

Various example balancing approaches described herein, which are simple and scalable, can result in significant system performance improvements in the presence of mismatches, while introducing no or at least minimal insertion loss penalties.

A balancing circuit for a plurality of series connected cells or substrings of cells is provided. In one implementation, the balancing circuit includes a plurality of primary ports; an isolated secondary port; and one or more DC-DC converters connected between the primary ports and the isolated secondary port. Each DC-DC converter includes at least one power switch. The DC-DC converters are configured to adjust a primary port current received at one or more of the plurality of primary ports based upon a difference between a voltage at the one of the primary ports and a reference voltage. Also provided are an electrical power system including such as balancing circuit and a method of balancing a plurality of electric cell substrings using such a balancing circuit.

In addition, examples of a simple and scalable cell balancing approach with built-in filtering are also provided. In various embodiments, the combined balancing and filtering circuits and control techniques result in significant system performance improvements in the presence of mismatches among the cells or substrings of cells. At the same time, the filtering is accomplished at reduced cost and with improved reliability.

A control technique for balancing circuits is also provided. The control technique, which applies to substring DC-DC converters, simplifies generation of reference signals, and simultaneously achieves balancing and voltage regulation across the secondary port of the substring DC-DC converters.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1, including FIGS. 1A and 1B, show an example photovoltaic module and an electrical circuit diagram of the photovoltaic module.

FIG. 2A shows a series connected photovoltaic modules or panels with a string or central inverter.

FIG. 2B shows photovoltaic modules with module-integrated DC-DC converters, also known as DC optimizers.

FIG. 2C shows photovoltaic modules with micro-inverters.

FIG. 3 shows a conventional battery system for hybrid electric vehicles (HEV), plug-in hybrid electric vehicles (PHEV), or electric vehicles (EV).

FIG. 4, including FIGS. 4A and 4B, show another example photovoltaic module and an electrical circuit diagram including an example implementation of a balancing circuit for the photovoltaic module.

FIG. 5 shows power versus voltage characteristics of the conventional PV module of FIG. 1, and of the PV module with the balancing circuit shown in FIG. 4.

FIGS. 6A, 6B and 6C show various implementations of substring DC-DC converters with isolation based on (a) an isolation transformer, (b) a transmission-line or coaxial isolation transformer, or (c) isolation capacitors 90, respectively.

FIG. 7 shows an example implementation of an electric power system with series-connected cells or cell substrings and a balancing circuit.

FIG. 8 shows another example implementation of an electric power system with series connected cells or cell substrings and a balancing circuit, with a secondary circuit connected to the secondary port.

FIG. 9 shows yet another example implementation of an electric power system with series connected cells or cell substrings and a balancing circuit.

FIGS. 10A through 10E show several embodiments of example cell substrings that may be used with the balancing circuits described herein.

FIG. 11 shows another example implementation of an electric power system with series connected battery cells or battery cell substrings and a balancing circuit.

FIG. 12 shows an example block diagram of a controller for a substring DC-DC converter in a balancing circuit.

FIGS. 13A through 13C show multiple examples of controller compensator steady-state (DC) characteristics.

FIG. 14 shows another example implementation of a controller for a substring DC-DC converter in one or more of the balancing circuits described herein.

FIGS. 15A and 15B show an example implementation of a photovoltaic module and an electrical circuit diagram including an example implementation of a balancing circuit for the photovoltaic module with a balancing and filtering circuit.

FIG. 16A shows an example implementation of an electrical power system in which an example implementation of a balancing/filtering circuit for the electrical power system is coupled to an AC output via a DC-AC inverter.

FIG. 16B shows example AC output waveforms of the balancing/filtering circuit shown in FIG. 16A.

FIG. 17A shows an example implementation of an electrical system comprising a plurality of series connected cells with a balancing circuit where a secondary port of the balancing circuit is isolated.

FIG. 17B shows an example implementation of an electrical system comprising a plurality of series connected cells with a balancing circuit where a secondary port of the balancing circuit is connected across the output of the string of series-connected cell substrings.

FIG. 18 shows an example implementation of a block diagram of a substring DC-DC converter controller.

FIG. 19 shows an example implementation diagram in which a central controller and only one module-level current sensor are provided.

FIG. 20 shows an example substring and a corresponding subMIC that regulates the substring voltage to a reference proportional to a secondary port voltage v_{mod}.

FIG. 21 shows an example distributed subMIC control approach that does not require a central controller.

FIG. 22 shows an example implementation of a photovoltaic array comprising a plurality of series-connected subMIC-enhanced modules having shared secondary ports and built-in balancing.

FIG. 23 shows an example implementation in which each subMIC is implemented as a bidirectional flyback converter.

FIG. 24A shows an example implementation of a photovoltaic system including a SubMIC-enhanced module and a microinverter.

FIG. 24B shows an example implementation of a photovoltaic system including a SubMIC-enhanced module and a DC optimizer.

FIG. 25 shows an example implementation of a photovoltaic system including a string of SubMIC-enhanced modules and one or more string inverters or a central inverter.

FIG. 26 shows another example implementation of a photovoltaic system including a string of SubMIC-enhanced modules and one or more string inverters or a central inverter in which an isolated secondary port is shared among the modules.

### DETAILED DESCRIPTION

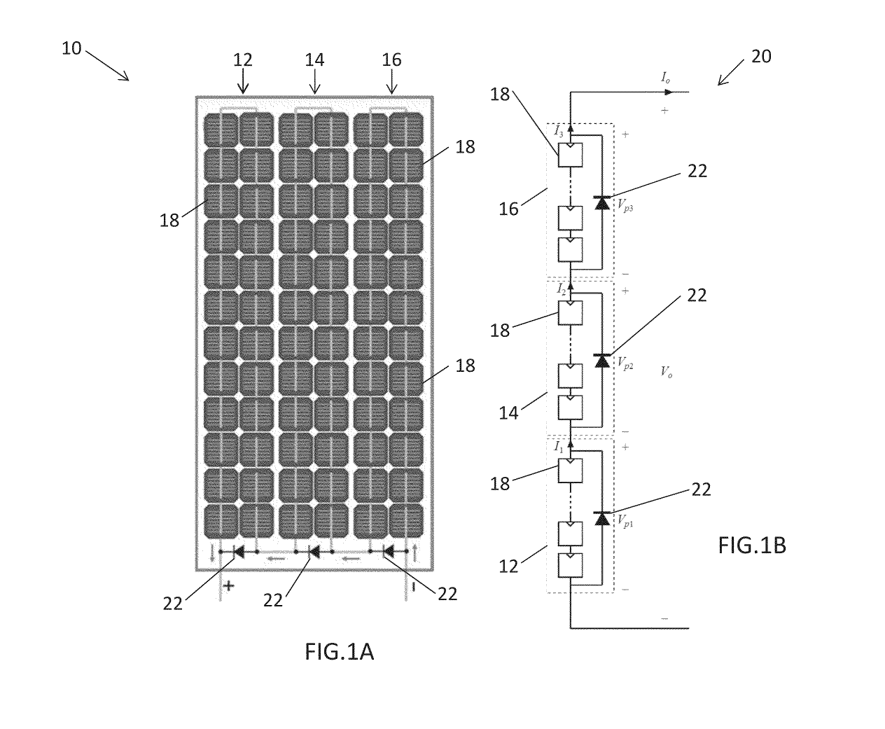

FIGS. 1A and 1B show an example photovoltaic (PV) module 10 and an electrical circuit diagram 20 of the photovoltaic module 10. In particular, FIG. 1A shows the photovoltaic module 10 including three photovoltaic cell substrings 12, 14, 16 connected in series with twenty four individual photovoltaic cells 18 per string 12, 14, 16. FIG. 1B shows the electrical circuit diagram 20.

In the example shown in FIGS. 1A and 1B, seventy two photovoltaic cells 18 are connected in series. The cells 18 are grouped in three series-connected substrings 12, 14, 16, with twenty four cells 18 connected in series in each substring 12, 14, 16. A parallel (also known as backplane or bypass) diode 22 is connected in parallel with each substring 12, 14, 16. A purpose of the backplane diode 22 is to prevent reverse bias and excessive power dissipation on the photovoltaic cells 16 (known as “hot spot”) when the photovoltaic module 10 is partially shaded. Partial shading occurs when the solar irradiation (also known as “insolation”) on some of the photovoltaic cells 18 is higher than the solar irradiation on other cells 18. Mismatches among photovoltaic cells are due to partial shading and other causes, such as manufacturing tolerances, temperature gradients, or dirt. The backplane diode 22 bypasses a weaker substring of photovoltaic cells 18 allowing the current of stronger substrings to flow through to the output. A reverse bias of the cells 18 in the weaker substring is prevented, thus averting hot-spot failures. However, conduction of bypass diodes 22 reduces the output voltage of the module 10 and thereby reduces the output power of the module 10 as well.

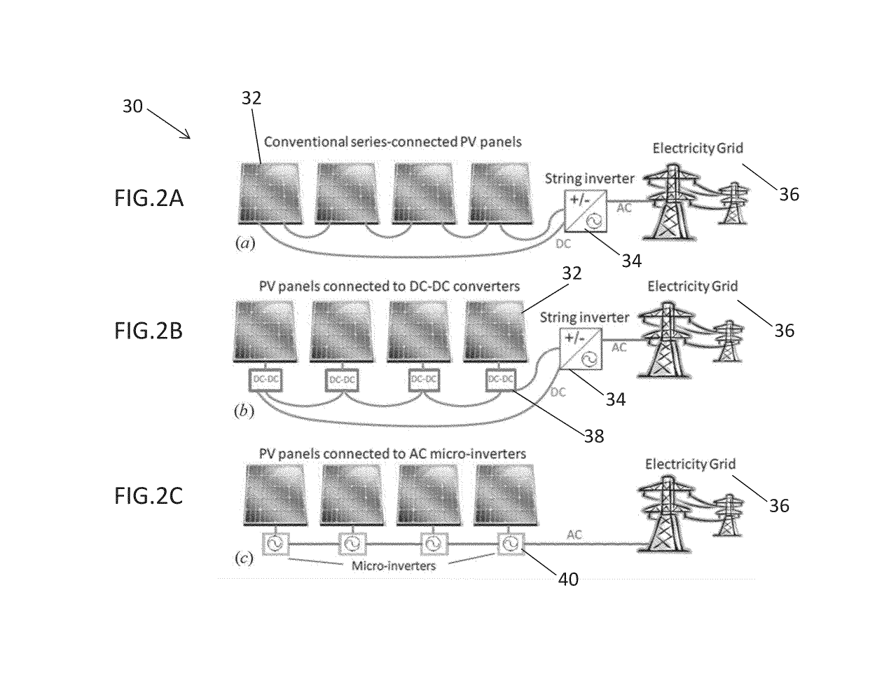

A conventional photovoltaic system 30 typically includes a number of photovoltaic modules 32 (such as the module 10 example shown in FIGS. 1A and 1B) connected in series, such as shown in FIG. 2A. The series connected modules 32 are coupled, such as via a string inverter 34, to an AC electric grid 36. The series connection of the plurality of photovoltaic modules 32 further exacerbates the mismatch-induced loss in power output and energy capture of each module, diminishing the efficiency of the photovoltaic system 30. It has been found that mismatches due to partial shading or other reasons result in significant losses in energy capture, especially in residential or commercial rooftop photovoltaic systems.

Many approaches have been proposed to address the mismatch-induced loss in efficiency and energy capture in photovoltaic systems, including module-integrated DC-DC converters 38 as shown in FIG. 2B, or micro-inverters 40 as shown in FIG. 2C. In these architectures, power electronics converters (DC-DC converters 38 or inverters 40) are distributed across the photovoltaic system and typically tied to each individual photovoltaic module 32. The converters 38 are controlled to perform per-module 32 maximum power point tracking, thus alleviating the loss in efficiency and energy capture due to mismatches among photovoltaic modules 32. However, the approaches based on module-integrated power electronics converters have several fundamental problems such as the following:

(1) the maximum power point tracking at the module level is not able to recover energy loss due to cell or substring mismatches within a module;

(2) power converters must process full photovoltaic module power at all times, which results in additional insertion losses even when all cells, substrings, and modules are well matched;

(3) power converters must be rated at full photovoltaic module power, which increases the converter and system cost.

The fact that substring or cell level power conversion could have significant potential benefits in improved photovoltaic system efficiency and improved energy capture has been discussed, but the problem of increased implementation cost and complexity has not been addressed. An approach based on partial power processing has been described, but it requires more complex installation and wiring, and more complex centralized system control.

In one implementation, for example, a simple, scalable and cost-effective balancing of photovoltaic cells or photovoltaic substrings within photovoltaic modules in photovoltaic power systems is provided herein.

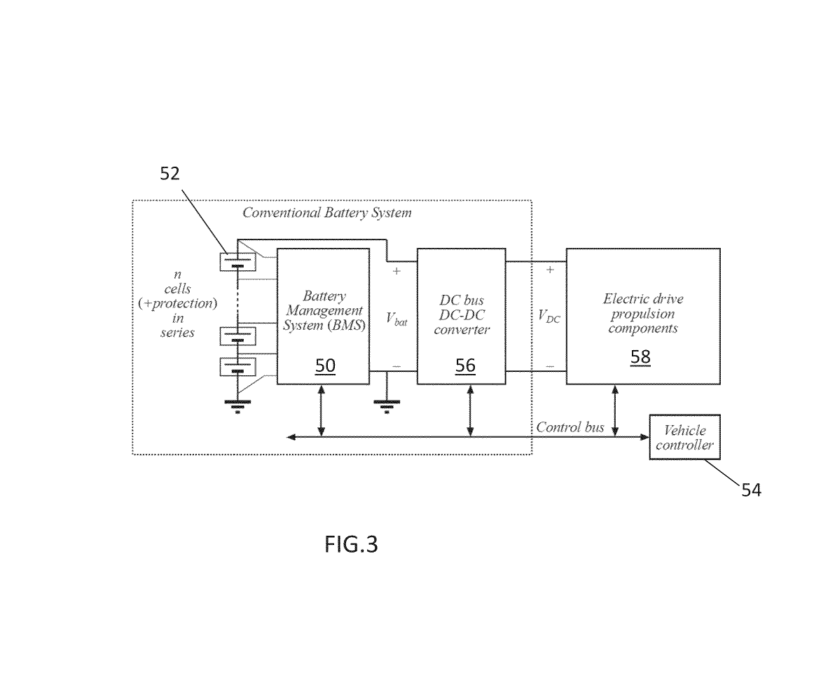

The problem of mismatch-related performance loss is also present in other electric power systems based on series-connected cells. For example, energy-storage systems typically include many electrochemical (battery) cells connected in series. For example, FIG. 3 shows a conventional battery system for hybrid electric vehicles (HEV), plug-in hybrid electric vehicles (PHEV), or electric vehicles (EV). Regardless of the chemistry specifics, a single battery cell voltage V_{cell} is relatively low (e.g., several volts). On the other hand, efficient operation of the electric drive propulsion (including power electronics inverters/rectifiers and electric machines) requires a relatively high DC voltage bus voltage V_{DC} (e.g., several hundred volts). The voltage mismatch between a battery cell and the DC bus voltage is commonly resolved by placing a large number (n) of battery cells in series, as shown in FIG. 3. With n in the order of 100, the resulting battery pack voltage V_{bat}=nV_{cell} is typically much closer to the required DC bus voltage V_{DC}. A fundamental problem in this system is related to the series connection of the battery cells: the system is only as good as the weakest cell in the string. Furthermore, if unattended, mismatches among the cells (e.g., due to manufacturing tolerances, temperature gradients across the pack, and mismatched degradation over cycle and calendar life) can lead to overcharging or excessive discharge of individual cells, resulting in rapid cell failures and severe cycle life limits. In the case of Lithium-Ion cell chemistries, which are considered most likely candidates for PHEV and EV applications, each cell in the string must include protection devices to prevent catastrophic failures due to overcharge, excessive discharge, or excess temperature.

A sophisticated battery management system (BMS) 50 is typically used around the string of cells 52, as shown in FIG. 3. The BMS 50 monitors current, temperature, as well as cell voltages to assess the battery state of charge (SOC) and the state of health (SOH), which are then communicated to a vehicle system controller 54. The BMS 50 functions include cell protection, charge control, operation of the battery pack within a target SOC window, and cell balancing, i.e. a way of compensating for weaker cells by equalizing the charge on all the cells 52 in the string and thus extending the battery system life. In practice, even with the BMS 50, the string length (i.e. the number n of cells 52 in series) is limited. An additional bidirectional DC bus DC-DC converter 56 is therefore often installed between the battery pack and the electric drive propulsion components 58, regulating the propulsion DC bus voltage V_{DC}. Cell balancing can be passive or active. In the passive case, balancing results in power losses and is relatively slow. Although many active balancing schemes have been proposed, a new simple, scalable and cost-effective cell balancing and power management is provided herein for battery systems.

Other electric power systems that benefit from simple, scalable and cost-effective balancing of series-connected cells or substrings include systems based on capacitors or super-capacitors, solid-state lighting (LED) systems, thermoelectric couples or other systems with electrical or electronic components or modules connected in series.

### Balancing Series-Connected Cells

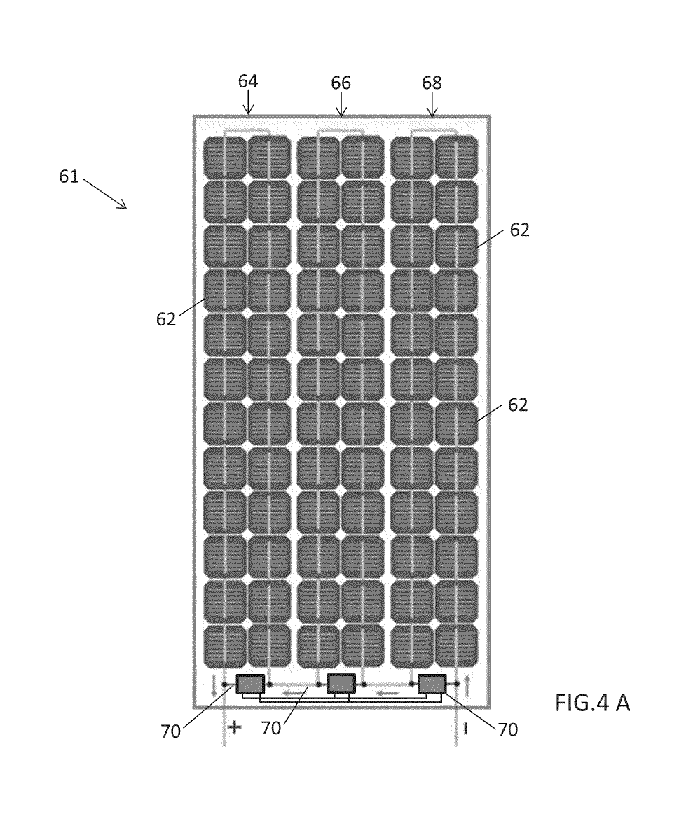

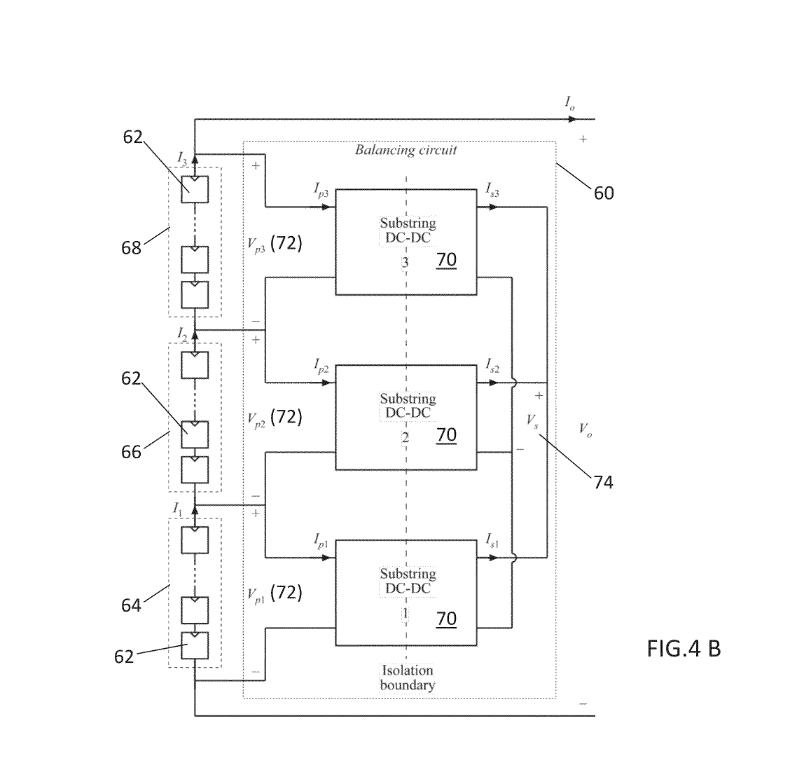

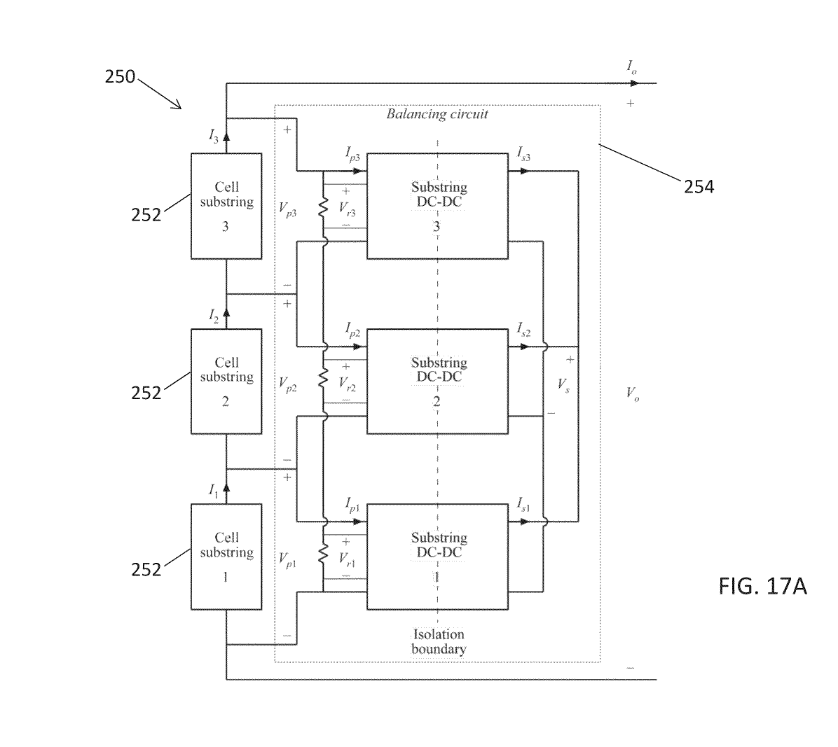

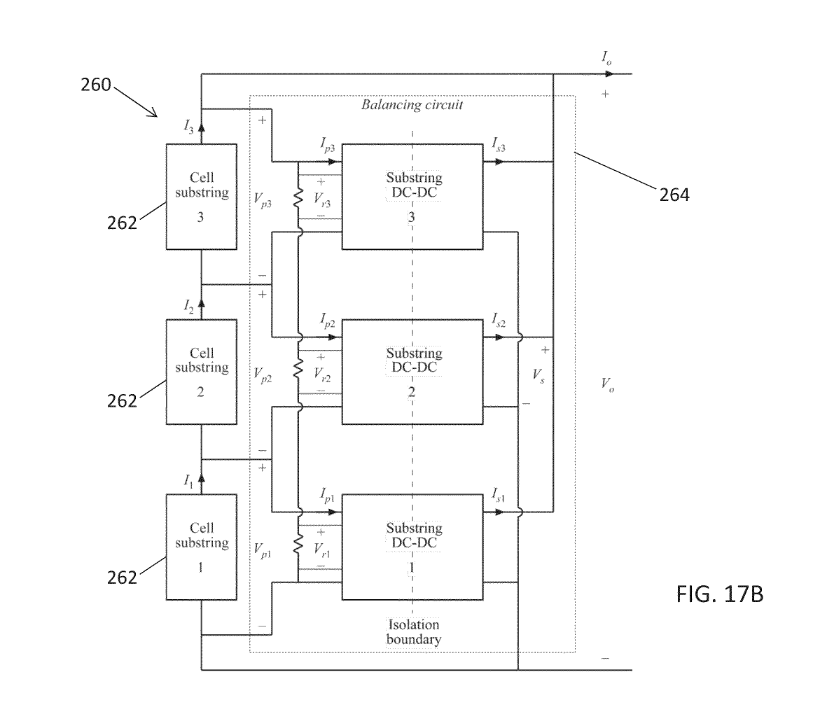

FIGS. 4A and 4B show an example implementation of a balancing circuit 60 for a plurality of series-connected cells, such as the shown series-connected photovoltaic cells 62. In this particular implementation, the balancing circuit 60 includes is shown in a typical photovoltaic module 61 having seventy two photovoltaic cells 62 arranged in three substrings 64, 66, 68, each substring 64, 66, 68 having twenty four photovoltaic cells 62 connected in series. The balancing circuit 60 comprises a plurality of substring DC-DC converters 70. A substring DC-DC converter, also called sub-module integrated converter or SubMIC 70 has a primary port (voltage Vₚ) 72 and an isolated secondary port (voltage Vₛ) 74. The secondary port and the primary port of the DC-DC converter are isolated. The primary port 72 of a substring DC-DC converter 70 is connected in parallel with a substring 64, 66, 68 of cells 62 in the photovoltaic module 61. The secondary ports 74 of all substring DC-DC converters 70 are connected in parallel. Each substring DC-DC converter comprises at least one controllable power switch. Additionally, each substring DC-DC converter 70 uses a reference voltage as described herein. The reference voltage, for example, may be proportional to the secondary isolated port voltage or proportional to the module output voltage Vₒ (e.g., FIGS. 17A and 17B). The balancing circuit 60 operates by diverting primary-port current (Iₚ>0) from, or by injecting primary-port current (Iₚ<0) to the corresponding cell substring 64, 66, 68. Consider, for example, the case when two substring currents are matched, I₁=I₂=I, while the third substring current is mismatched, I₃=0, so that the total output power available from the substrings 64, 66, 68 is reduced by one third. In response, the substring DC-DC converter currents are adjusted by controlling the power switch so that Iₚ₁=Iₚ₂=I/3, while Iₚ₃=−2I/3. As a result, the photovoltaic module output current is Iₒ=I₁−Iₚ₁=I₂−Iₚ₂=I₃−Iₚ₃=2I/3, which shows how, using the balancing circuit 60, the module output power equals the total available power from the substrings 64, 66, 68, without a loss of the available power. In the case when all substrings 64, 66, 68 are matched, i.e. when all substring currents are the same, I₁=I₂=I₃=I the substring DC-DC converters 70 are shut down so that Iₚ₁=Iₚ₂=Iₚ₃=0, and the module output current simply equals the substring current, Iₒ=I. In the well matched case, the balancing circuit adds no insertion or other losses.

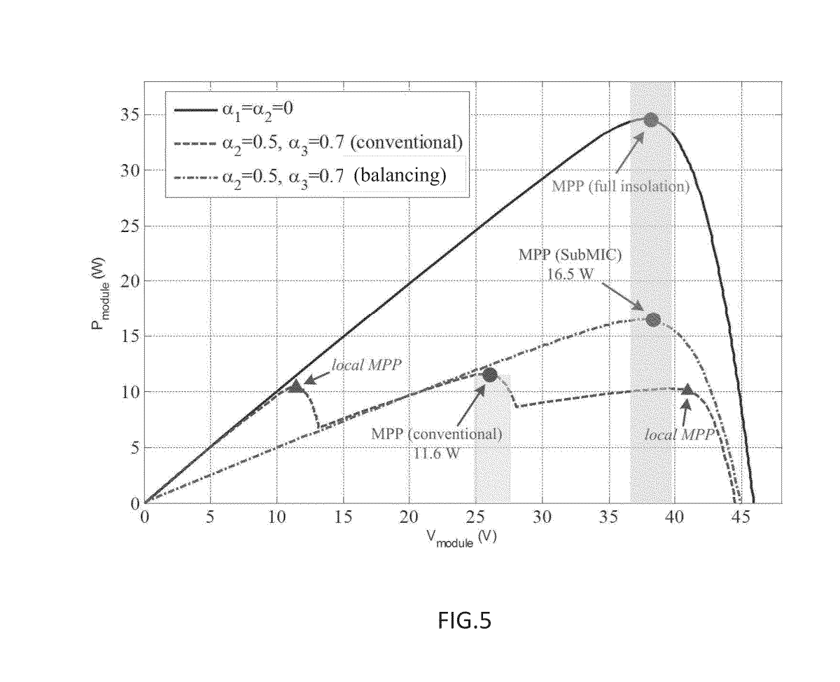

As another example, consider the case when the first substring 64 is fully irradiated, while the second and third substrings 66 and 68 are shaded to α₂=50% and α₃=70%, respectively. In this example, FIG. 5 shows power versus voltage characteristics of the conventional PV module of FIG. 1 (shown as MPP (conventional)), and of the PV module with the balancing circuit 60 shown in FIG. 4 (shown as MPP (full insolation) and MPP (SubMIC)). At a maximum power point, the module with the balancing circuit produces 40% more power than the conventional PV module. Furthermore, the maximum power point (MPP) in the module with the balancing circuit occurs at the voltage which is nearly the same as the MPP voltage when the module is fully irradiated. This nearly-constant voltage output of the PV module with the balancing circuit is very beneficial to reduce cost and improve efficiency of follow-up power electronics in PV systems.

In this implementation, it can be noted that the substring DC-DC converters (or SubMICs) in the balancing circuit process only the mismatch portion of power, which means that the substring converters 70 can be significantly smaller in size and cost compared to other module integrated converters or microinverters. Furthermore, in some implementations, the converters 70 introduce no insertion or other losses when the cells or substrings are well matched, thus maximizing or at least increasing the PV system efficiency and energy capture under all operating conditions.

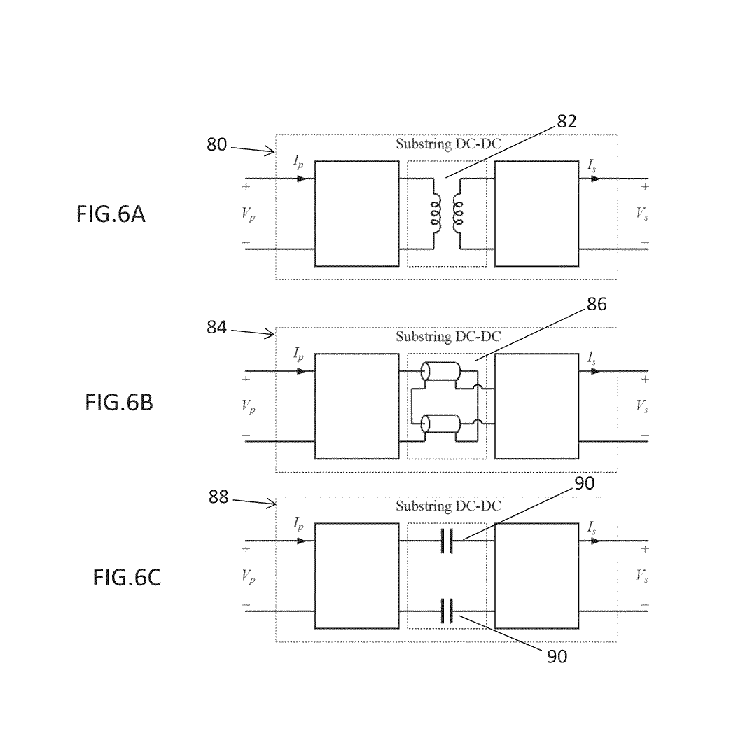

The substring DC-DC converters 70 shown in FIG. 4 have isolation between the primary port and the secondary port. FIGS. 6A, 6B and 6C show various implementations of substring DC-DC converters 80, 84, 88 with isolation based on (a) an isolation transformer 82, (b) a transmission-line or coaxial isolation transformer 86, or (c) isolation capacitors 90. Many well known converter configurations are available to realize isolated substring DC-DC converters (or SubMICs). The substring DC-DC converter with transformer isolation (shown in FIG. 6A), for example, can be Flyback, Forward, Cuk, Sepic, push-pull, half-bridge, full-bridge, or any other of many available converter configurations.

The substring DC-DC converter with isolation (shown in FIG. 6) can be, for example, a resonant converter such as series-resonant converter, parallel-resonant converter, LLC resonant converter, or radio-frequency resonant converter. When the substring DC-DC converter is a resonant converter where the primary port current depends on a difference between the primary port and secondary port voltages, a simple open-loop switch control is sufficient for balancing.

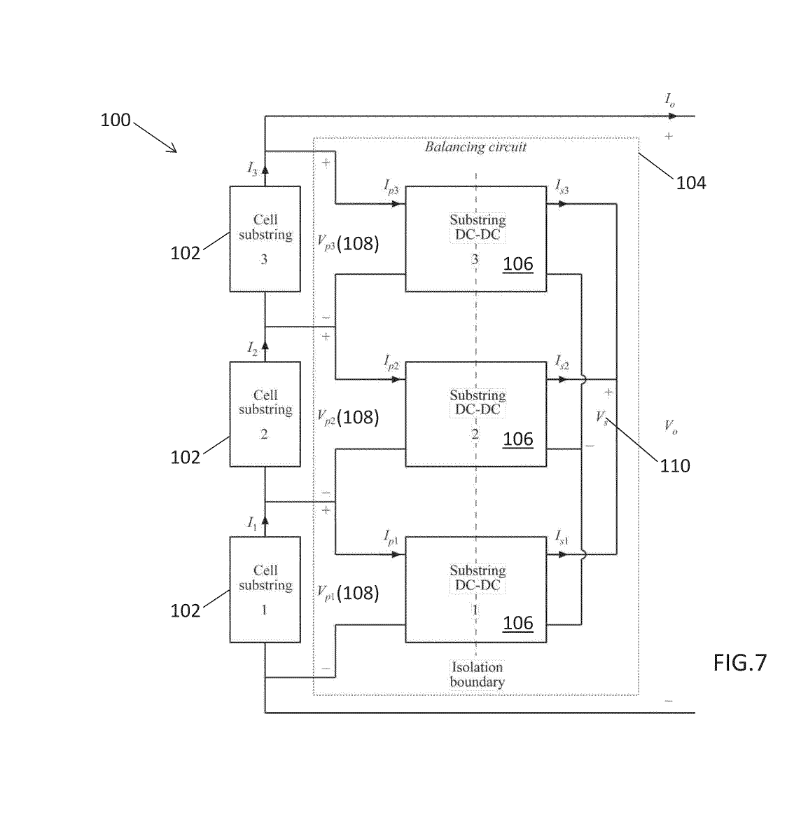

FIG. 7 shows an example implementation of an electric power system 100 with series-connected cells or cell substrings 102 and a balancing circuit 104. The balancing circuit 104 comprises a plurality of substring DC-DC converters 106. Each substring DC-DC converter 106 has a primary port 108 and a secondary port 110, which are isolated. The primary port 108 is connected in parallel with a cell substring 102 so it can add or subtract the current in order to balance the cell substrings 102. The secondary ports 110 of the substring DC-DC converters 106 are connected in parallel. In the implementation shown in FIG. 7, only the secondary ports 110 of the substring DC-DC converters 106 and no other circuits are connected in parallel to form secondary voltage Vₛ. Thus, the secondary ports 106 are isolated. Each substring DC-DC converter 106 further determines or receives a reference voltage proportional to the secondary isolated port voltage.

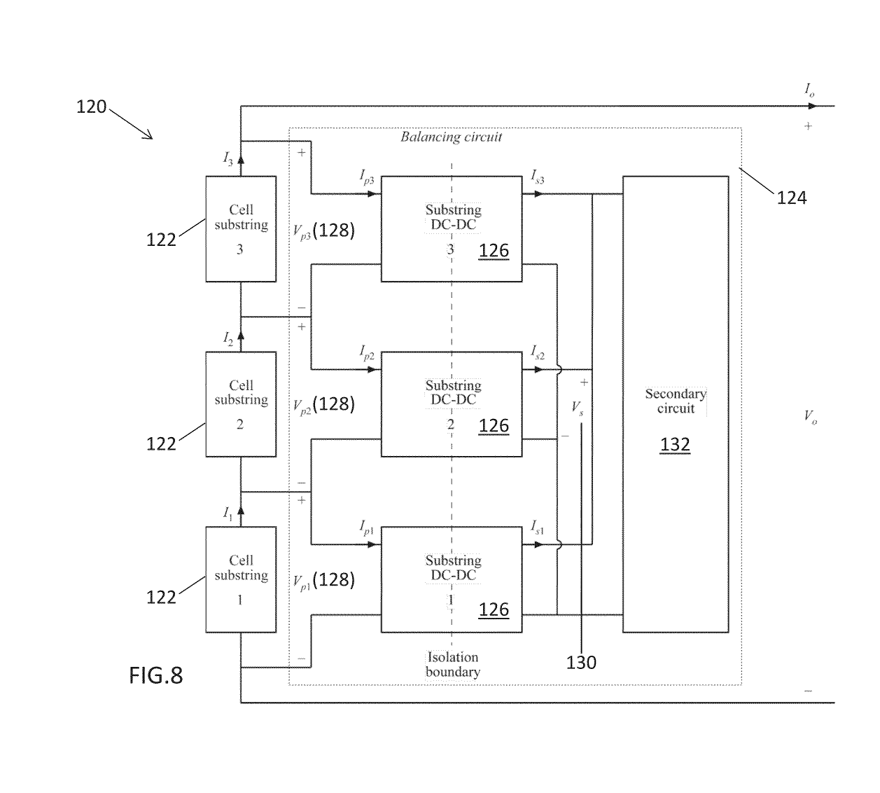

FIG. 8 shows another example implementation of an electric power system 120 similar to the electric power system 100 shown in FIG. 7. In the implementation shown in FIG. 8, the electric power system 120 comprises a plurality of cell substrings 122 coupled to a balancing circuit 124. In this implementation, the balancing circuit 124 comprises a plurality of substring DC-DC converters 126. Each substring DC-DC converter 126 has a primary port 128 and a secondary port 130. The primary port 128 is connected in parallel with a cell substring 122 so it can add or subtract the current in order to balance the cell substrings 122. The secondary ports 130 of the substring DC-DC converters 106 are connected in parallel and are further coupled to an additional secondary circuit 132. The secondary circuit 132 can be, for example, a voltage source or sink, a current source or sink, a power source or sink, a load, or another power converter. Each substring DC-DC converter 126 further determines or receives a reference voltage proportional to the secondary isolated port voltage, or a reference voltage proportional to the electric power system output voltage Vₒ.

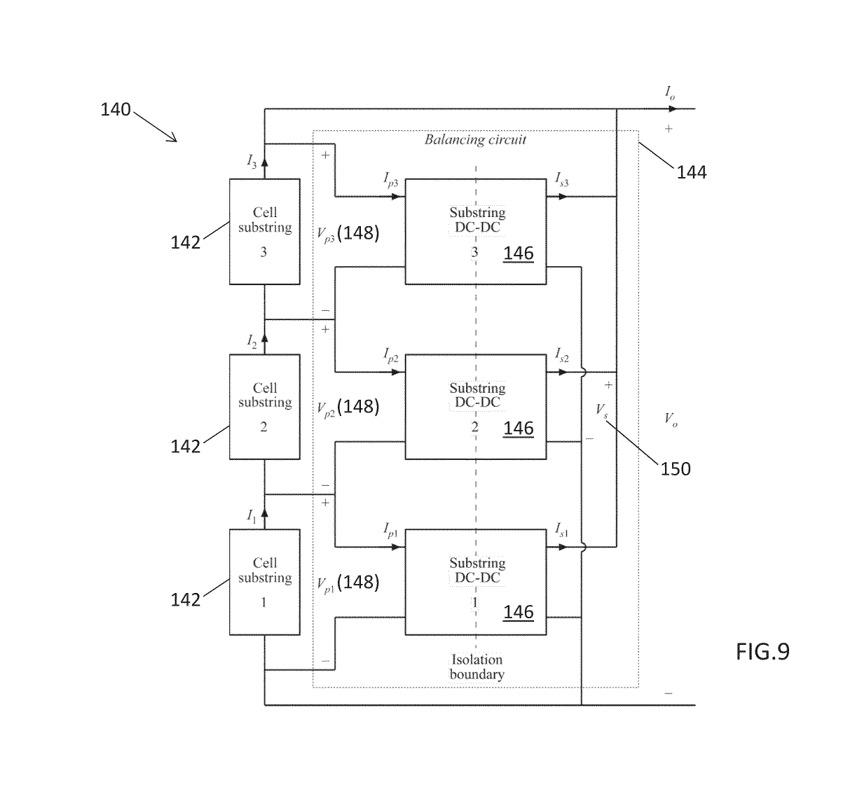

FIG. 9 shows yet another example implementation of an electric power system 140 similar to the electric power systems 100 and 120 shown in FIGS. 7 and 8. In the implementation shown in FIG. 9, the electric power system 140 comprises a plurality of cell substrings 142 coupled to a balancing circuit 144. In this implementation, the balancing circuit 144 comprises a plurality of substring DC-DC converters 146. Each substring DC-DC converter 146 has a primary port 148 and a secondary port 150. The primary port 148 is connected in parallel with a cell substring 142 so it can add or subtract the current in order to balance the cell substrings 142. The secondary ports 150 of the substring DC-DC converters 146 are connected in parallel and are further coupled across the power system output. Each substring DC-DC converter 146 further determines or receives a reference voltage proportional to the secondary isolated port voltage.

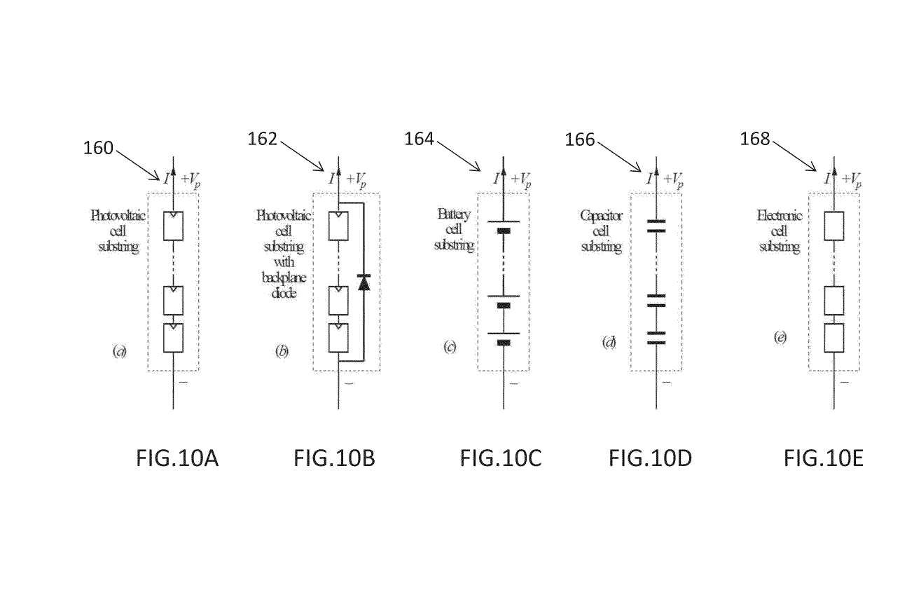

FIGS. 10A through 10E show several embodiments of example cell substrings that may be used with the balancing circuits described herein. FIG. 10A, for example, shows a photovoltaic cell substring 160 comprising one or more series-connected photovoltaic (PV) cells without a diode coupled in parallel to the cells, while FIG. 10B shows a second photovoltaic cell substring 162 in which a diode is coupled in parallel to the one or more of the series-connected cells of the substring 162. FIG. 10C shows a battery cell substring 164 comprising one or more series-connected electrochemical (battery) cells. FIG. 10D shows a capacitor cell substring 166 comprising one or more series-connected capacitors. FIG. 10E shows an electronic cell substring 168 comprising one or more electrical or electronic components or modules. Although not shown in FIG. 10, a thermoelectric couple substring 170 may comprise one or more series-connected thermoelectric couple cells.

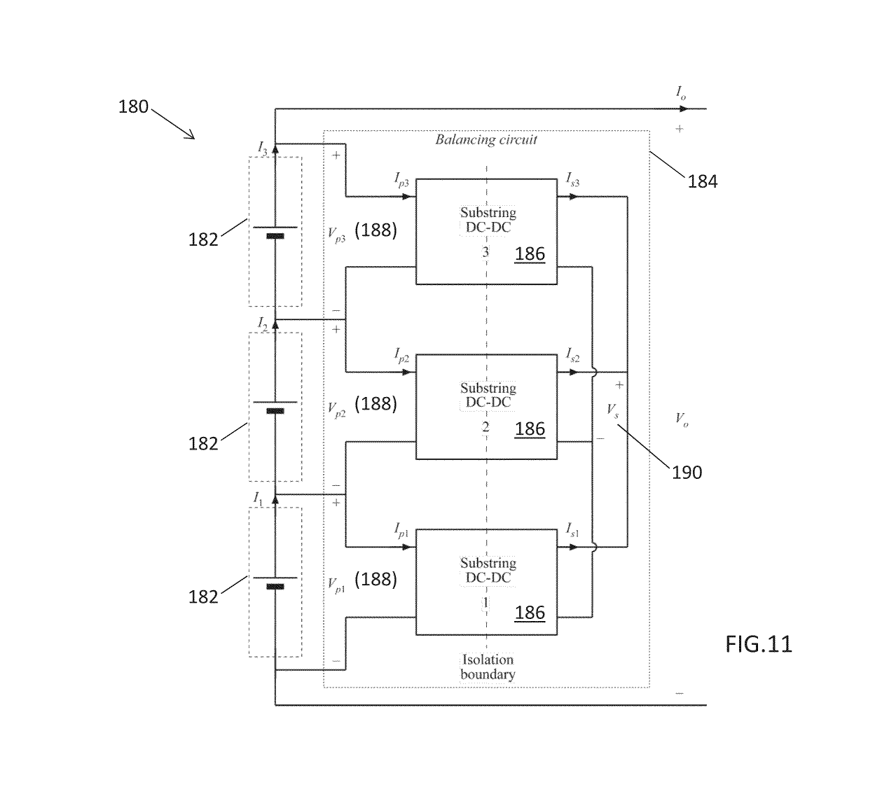

FIG. 11 shows an example implementation of a battery system 180 comprising a plurality of battery cells 182 connected in series and a balancing circuit 184. The balancing circuit 184 comprises a plurality of isolated DC-DC converters 186. Each of the DC-DC converters 186 has a primary port 188 connected across a battery cell 182, and a secondary port 190 isolated from the primary port 188. The secondary ports 190 of the DC-DC converters 186 are connected in parallel to a secondary port V_{S} of the balancing circuit 184. The secondary port V_{S} of the balancing circuit 184 is isolated. Each substring DC-DC converter 146 further determines or receives a reference voltage proportional to the secondary isolated port voltage, or a reference voltage proportional to the battery system output voltage Vₒ.

### Control Techniques

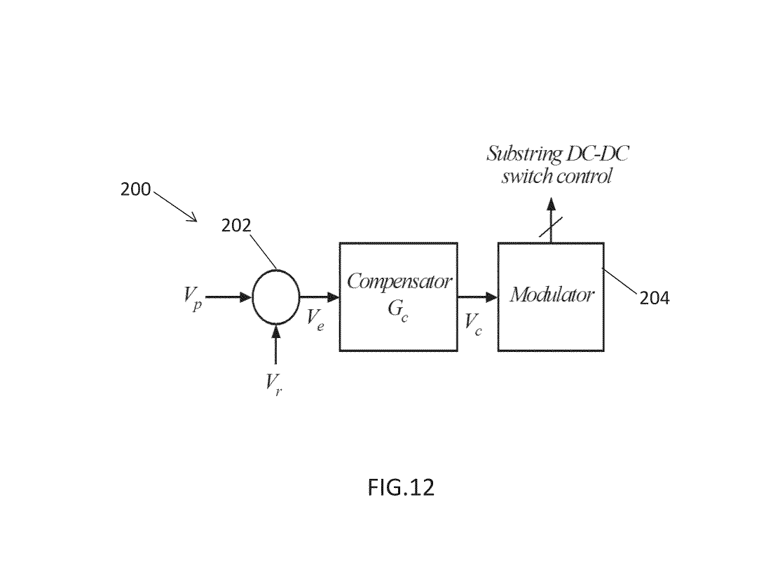

In various implementations, a substring DC-DC converter in the balancing circuits described herein has a controller 200 capable of adjusting a converter primary port current in order to balance the cells. The balancing is accomplished by comparing the primary port voltage Vₚ to the reference voltage Vᵣ at a comparator 202, for example as shown in FIG. 12. In one particular implementation, an error Vₑ between the primary port voltage and the reference voltage is processed by a compensator G_{c} to produce a control signal V_{c} at the input of a modulator 204. In response to the control signal V_{c}, the modulator 204 generates control signals for switches in the substring DC-DC converter so that the primary port current Iₚ is proportional to the control signal V_{c}.

The reference voltage Vᵣ can be proportional to the secondary port voltage Vₛ. This option can be applied in embodiments such as those shown in FIG. 4B, FIG. 7, FIG. 8, FIG. 9, or FIG. 11. Another option is to have the reference voltage Vᵣ proportional to the system output voltage, as shown, for example, in FIGS. 17A and 17B. The control techniques described here apply to either one or a combination of these options available to generate the reference voltage Vᵣ. FIGS. 17A and 17B show two implementations of balancing circuits 250, 260 comprising substring DC-DC converters connected across cell substrings. FIG. 17A, for example, shows a case where a secondary port of the balancing circuit 250 is isolated, while FIG. 17B shows a case where a secondary port of the balancing circuit 260 is connected across the output of the string of series-connected cell substrings. FIGS. 17A and 17B show example implementations of an electrical system comprising a plurality of series connected cells 252, 262 with a balancing circuit 254, 264. In the balancing circuits 254, 264, reference voltages are obtained by a voltage divider circuit 256, 266 with an isolated secondary port (FIG. 17A) and with the secondary port connected across a string of series connected cell substrings (FIG. 17B).

Consider the system with the balancing circuit shown in FIG. 7. By Kirchhoff's current law,

Iₒ=I₁−Iₚ₁=I₂−Iₚ₂=I₃−Iₚ₃ (1)

By Kirchhoff's voltage low,

Vₒ=V_{p,1}+V_{p,2}+V_{p,3} (2)

Consider further the case when the reference voltages are all equal and proportional to the system output voltage,

$${V}_{r 1} = {V}_{r 2} = {V}_{r 3} = {V}_{r} = \frac{1}{3} {V}_{o} \qquad ( 3 )$$

In one implementation, the compensator DC gain G_{c}(0)=Gₒ is a finite positive value, and

C_{c,i}=GₒV_{e,i}=Gₒ(V_{p,i}−Vᵣ) (4)

The modulator controls the DC-DC converter so that the primary port current is proportional to the control signal V_{c},

I _{p,i}=GₘV_{c,i}=GₘGₒ(V_{p,i}−Vᵣ)=Kₒ(V_{p,i}−Vᵣ) (5)

where Kₒ=GₘGₒ is a finite, positive value. Solving Equation (5) for V_{p,i},

$${V}_{p , i} = {V}_{r} + \frac{1}{{K}_{o}} {I}_{p , i} \qquad ( 6 )$$

Inserting V_{p,i} for i=1, 2, 3 from Equation (6) into Equation (2),

$${V}_{o} = {V}_{r} + \frac{1}{{K}_{o}} {I}_{p , 1} + {V}_{r} + \frac{1}{{K}_{o}} {I}_{p , 3} + {V}_{r} + \frac{1}{{K}_{o}} {I}_{p , 3} = 3 {V}_{r} + \frac{1}{{K}_{o}} ( {I}_{p , 1} + {I}_{p , 2} + {I}_{p , 3} ) \qquad ( 7 )$$

which, taking into account Equation (3), implies that the balancing DC-DC controller results in

I_{p,1}+I_{p,2}+I_{p,3}=0 (8)

From Equation (1), it follows that the system output current is equal to the average of the substring currents,

$${I}_{o} = \frac{1}{3} ( {I}_{1} + {I}_{2} + {I}_{3} ) = 0 \qquad ( 9 )$$

The DC-DC converter primary port currents are:

$$\begin{matrix}{I}_{p 1} = {I}_{1} - {I}_{o} = \frac{2}{3} {I}_{1} - \frac{1}{3} ( {I}_{2} + {I}_{3} ) & ( 10 ) \\ {I}_{p 2} = {I}_{2} - {I}_{o} = \frac{2}{3} {I}_{2} - \frac{1}{3} ( {I}_{1} + {I}_{3} ) & ( 11 ) \\ {I}_{p 3} = {I}_{3} - {I}_{o} = \frac{2}{3} {I}_{3} - \frac{1}{3} ( {I}_{1} + {I}_{2} ) & ( 12 )\end{matrix}$$

The corresponding primary port voltages can then be found from Equation (6). It can be observed that in this embodiment the controller results in primary-port voltages close to but not necessarily equal to the reference voltage. Gain Kₒ can be selected to adjust voltage regulation performance in the presence of mismatches. In the case when all susbstrings are well matched, i.e. when I₁=I₂=I₃, Equations (10)-(12) show that the primary-port currents are all equal to zero. In other words, in a well matched system, the DC-DC converters need not process any power.

Based on the control approach described above, each DC-DC converter can be controlled autonomously, without the need for a central system controller or any communication of control or sensing signals among the DC-DC converters. As a result, the control is simple and scalable to any number of DC-DC converters in the balancing circuit.

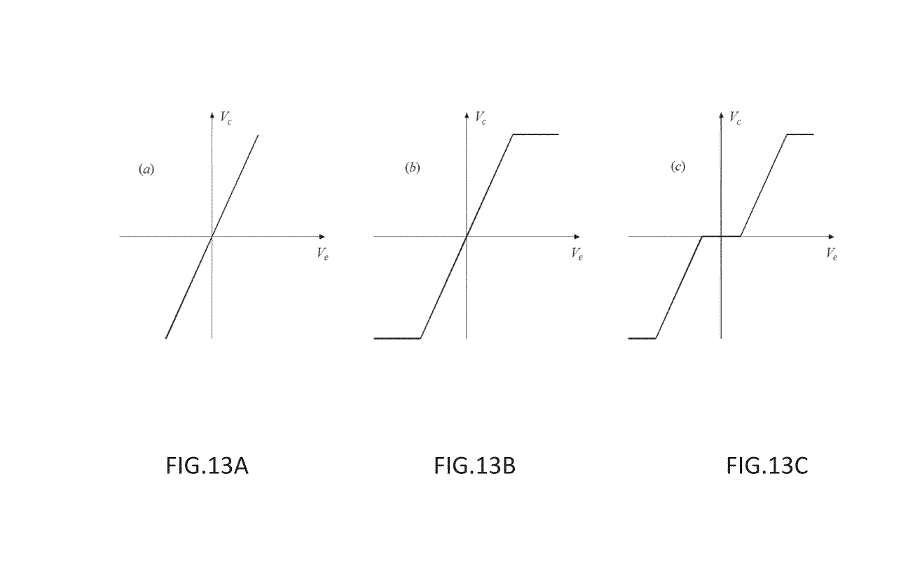

Many variations of the controller embodiments are possible. FIGS. 13A through 13C show several examples of controller compensator steady-state (DC) characteristics. FIG. 13A shows a gain Gₒ. FIG. 13B shows a gain Gₒ with saturation limits, and FIG. 13C shows a gain Gₒ with dead zone and saturation limits. The frequency response G_{c}(s) can be designed to ensure stable and fast response of the balancing circuit. Furthermore, the controller modulator can have many different embodiments, for example based on a pulse-width modulator, an on/off hysteretic modulator, or a current-mode modulator.

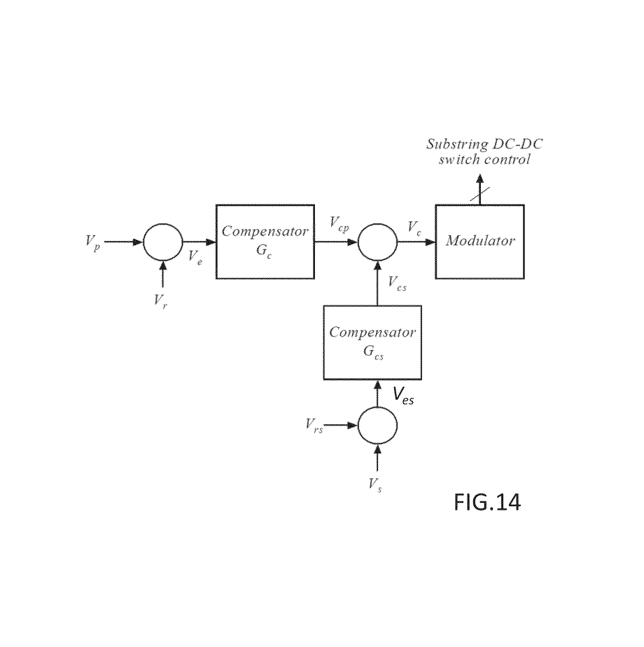

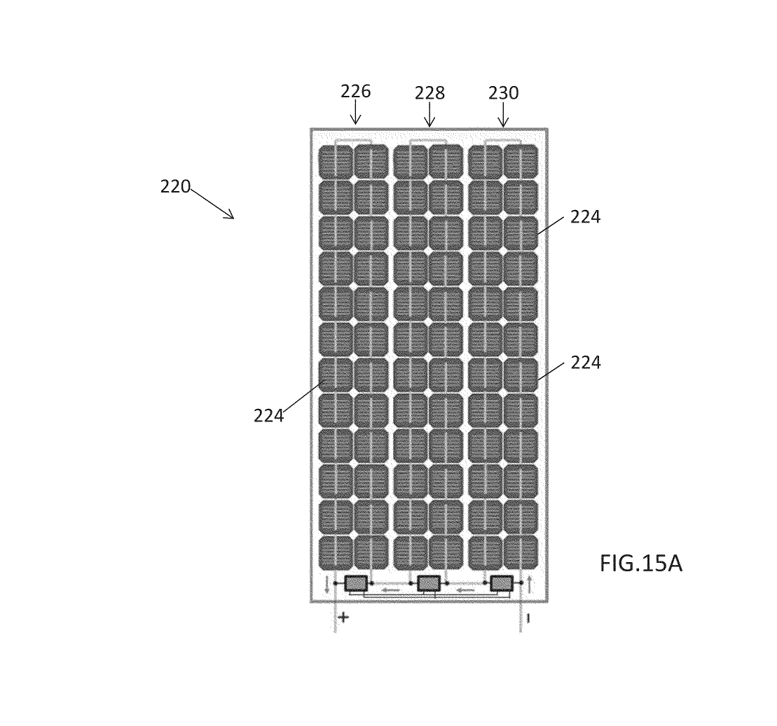

FIG. 14 shows another example implementation of a controller 210 for a substring DC-DC converter in one or more of the balancing circuits described herein. In this implementation, a secondary port voltage Vₛ is further compared at a comparator 212 to a reference Vᵣₛ, and the secondary port voltage error Vₑₛ is used to modify a modulator control input V_{cp}. The secondary-port voltage feedback loop is designed to regulate the secondary voltage to the secondary reference Vᵣₛ so that in steady-state operation Vₛ=Vᵣₛ, and the primary voltage control operates as previously described.

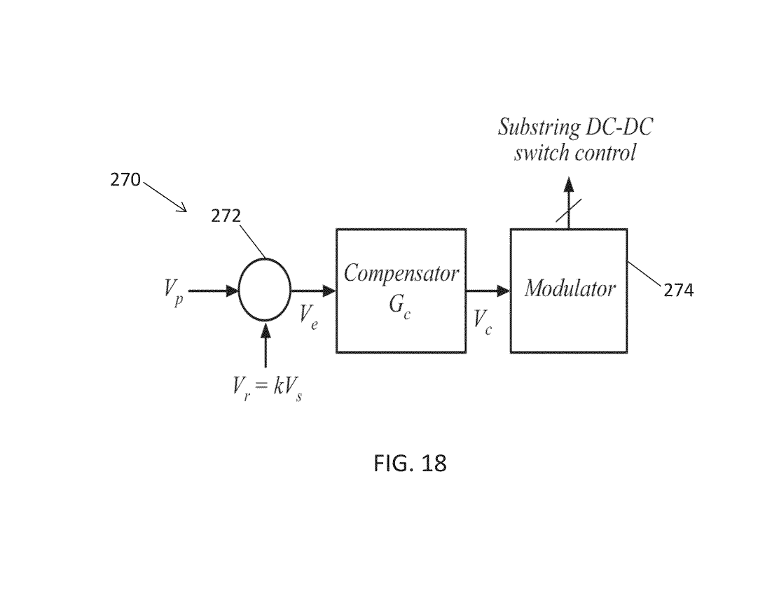

FIG. 18 shows an example implementation of a block diagram 270 of a substring DC-DC converter controller based on an example control technique. In this implementation, a voltage proportional to a substring converter primary port voltage Vₚ is compared at a comparator 272 to a reference Vᵣ. The reference Vᵣ is proportional to a substring secondary port voltage Vₛ. An error signal, i.e. the difference between Vₚ and Vᵣ is processed by a compensator G_{c}. The output of the compensator is the input to a modulator 274 that generates control signals for the substring DC-DC converter, so that Vₚ is essentially regulated at a value set by Vᵣ. The compensator shown in FIG. 18 can be implemented using any of well-known control techniques. In the system of FIG. 7, for example, this control technique results in balancing of series connected cell substrings, while simultaneously regulating the secondary port voltage Vₛ.

When the substring DC-DC converter is a resonant converter where the primary port current depends on a difference between the primary port and secondary port voltages, a simple open-loop switch control is sufficient for balancing.

In various example implementations, a balancing circuit is provided for a series-connected cells or cell strings. In some of these implementations, the balancing circuits provide cell balancing and optimization of system performance in terms of efficiency, power output, energy capture, energy storage capacity or lifetime under all or many operating conditions using DC-DC converter processing only a mismatch portion of system power. Where the DC-DC converters are processing only a mismatch portion of the system power, the DC-DC converters in the balancing circuit are rated at a portion of the system power, reducing the overall system cost. Further, the balancing circuit can introduce no insertion or other losses when the cells or strings of cells in the system are well matched. The control of DC-DC converters can be performed locally, without the need for a central controller or communication of control and sensing signals. In addition, the balancing circuit is scalable to systems with arbitrarily large number of cells in series.

### Filtering Series-Connected Cells

In a grid-tied PV system (e.g., FIGS. 2A-2C) or a photovoltaic system with an AC output, the mismatch between the DC output of series-connected cells, substrings or modules and the AC output is commonly filtered using capacitors or other types of energy storage devices. The required filtering components, typically based on capacitive energy storage, are responsible for increased system cost, reduced system reliability or reduced efficiency of DC-AC inverters. An active filtering approach can be applied to reduce required energy storage and power processing related to filtering. The approach could be applied to PV systems, but would require additional active components, and would result in reduced system efficiency.

In various implementations described herein, for AC-output systems (e.g., photovoltaic systems), a cost-effective, reliable filtering is also provided in a simple and scalable cell balancing approach with built-in filtering.

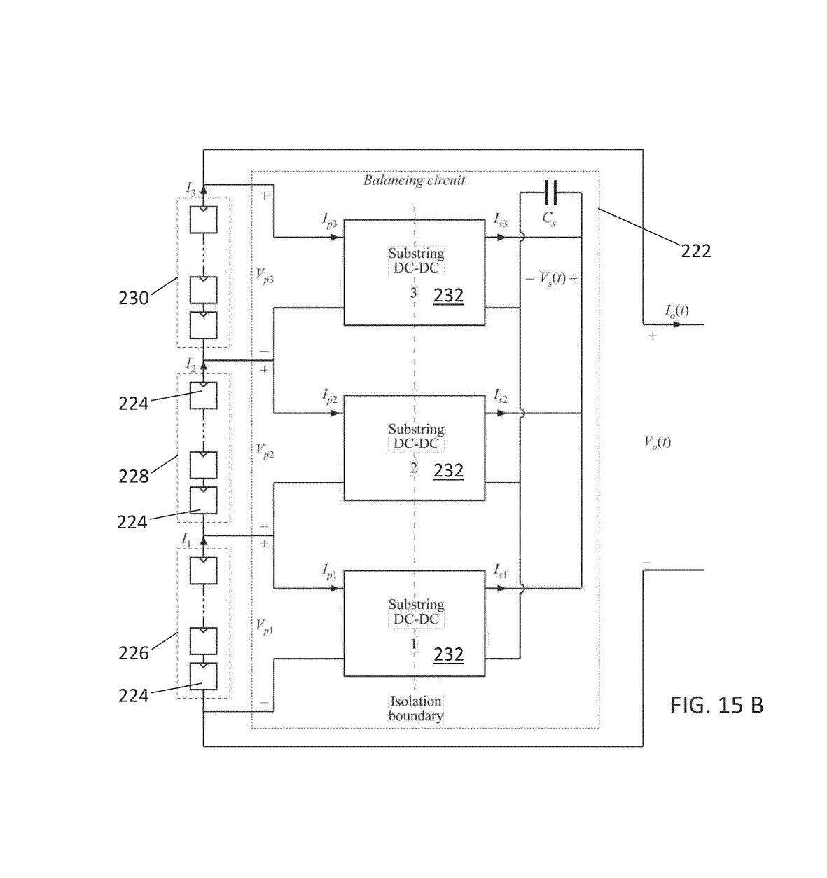

FIGS. 15A and 15B show an example implementation of a photovoltaic module 220 with a balancing and filtering circuit 222. The photovoltaic module 220 with balancing/filtering circuit 222 is similar to the balancing circuits shown and described above (see, e.g., FIGS. 4A and 4B), with an additional filter capacitor Cₛ disposed across the isolated secondary port.

In this implementation, the balancing/filtering circuit 222 is shown in photovoltaic module having seventy two photovoltaic cells 224 arranged in three substrings 226, 228, 230. Each substring includes twenty four photovoltaic cells 224 connected in series. The balancing/filtering circuit 222 comprises a plurality of substring DC-DC converters 232. A substring DC-DC converter 232 has a primary port (voltage Vₚ) and an isolated secondary port (voltage Vₛ). The secondary port and the primary port of the substring DC-DC converters 232 are isolated. The primary port of a substring DC-DC converter 232 is connected in parallel with a substring 226, 228 or 230 of cells 224 in the photovoltaic module 220. The secondary ports of all substring DC-DC converters 232 are connected in parallel. Additionally, each substring DC-DC converter 232 uses a reference voltage proportional to the secondary isolated port voltage. The balancing circuit operates by diverting primary-port current (Iₚ>0) from, or by injecting primary-port current (Iₚ<0) to the corresponding cell substring as described above. Furthermore, the filtering capacitor Cₛ and the operating voltage Vₛ can be selected to provide filtering in AC-output PV systems using the module shown in FIGS. 15A and 15B.

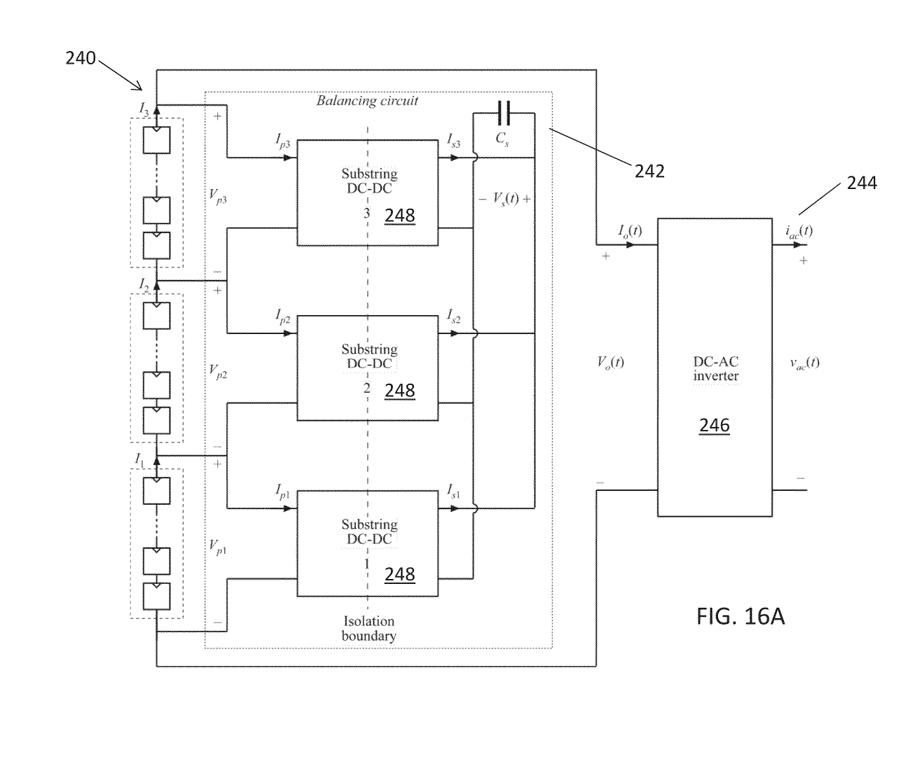

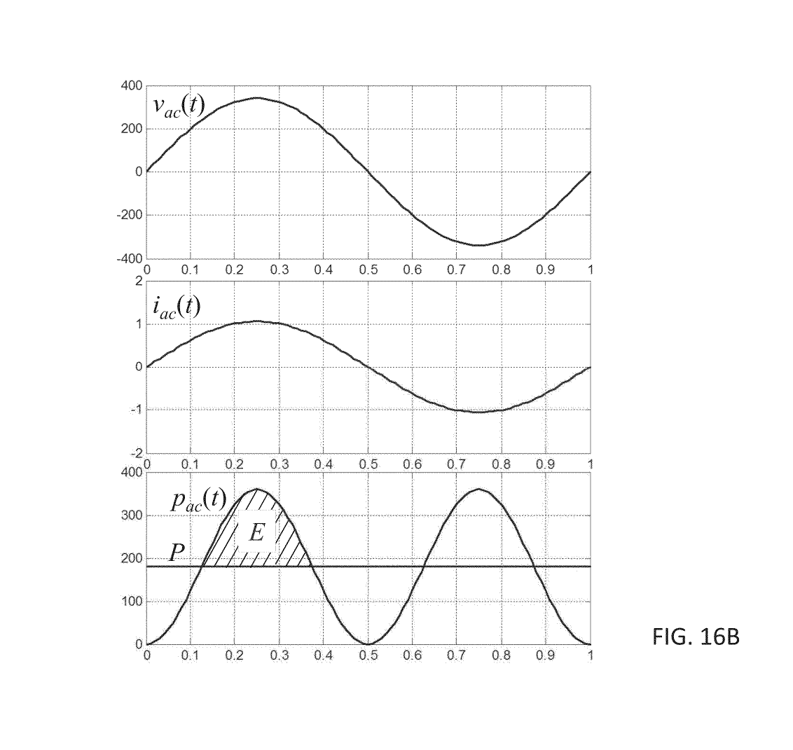

FIG. 16A shows a photovoltaic system 240 where a module with built-in balancing and filtering circuit 242, such as shown in FIG. 15B, is coupled to an AC output 244 using a DC-AC inverter 246. The inverter 246 shown could be, for example, a string inverter or a micro-inverter. A control for the substring DC-DC converters 248 is the same as described above with reference to FIGS. 12 through 14, but with the reference voltages Vᵣ further filtered to substantially remove any components at the AC line frequency or harmonics of the AC line frequency. With Vᵣ reference voltages being essentially DC, the control approach described in above achieves balancing and filtering simultaneously or near simultaneously. As a result, Vₒ(t) is substantially DC voltage with a small AC ripple, while Iₒ(t) can include substantial AC line frequency components. For example, if output AC voltage v_{ac}(t) and output AC current i_{ac}(t) are substantially sinusoidal at AC line frequency, Iₒ(t) is a rectified sinewave waveshape. The AC component of Iₒ(t) is diverted through substring DC-DC converters 248, and filtered by the energy-storage filtering capacitor Cₛ connected across the secondary port.

FIG. 16B shows example AC output waveforms of the balancing/filtering circuit 242 shown in FIG. 16A. The AC output waveforms include an AC output voltage v_{ac}(t), an AC output current i_{ac}(t) and an AC output power p_{ac}(t). Energy E shows the amount of energy that may be deposited on or restored from the energy-storage filtering capacitor Cₛ connected across the secondary port.

In a case when energy storage is integrated within the balancing circuit, the reference Vᵣ can be obtained by low-pass filtering the secondary port voltage Vₛ.

The same balancing/filtering circuit can also be applied to other AC-output or AC-input power systems based on series connected cells or substrings, such as systems based on capacitors or super-capacitors, solid-state lighting (LED) systems, thermoelectric couples or other systems with electrical or electronic components or modules connected in series.

In various example implementations, a balancing and filtering circuit is provided for a series-connected cells or cell strings. In some of these implementations, the balancing and filtering circuits provide effective cell balancing and optimization of system performance in terms of efficiency, power output, energy capture, energy storage capacity or lifetime accomplished under all or many operating conditions using DC-DC converters processing only a mismatch portion of system power. Further, the balancing and filtering circuit can introduce no insertion or other losses when the cells or strings of cells in the system are well matched. In photovoltaic systems with an AC output, the filtering can be accomplished actively, thus reducing the cost the required energy-storage, filtering capacitors, while re-using the balancing DC-DC converters. The filtering and improved reliability are accomplished at low cost and at high efficiency. The control of the substring DC-DC converters can be performed locally, without the need for a central controller or communication of control and sensing signals. The balancing/filtering circuit is scalable to systems with arbitrarily large number of cells in series. Photovoltaic modules with a built-in balancing/filtering circuit can also be used in all or many types of photovoltaic systems with an AC output.

### Substring DC-DC Converters or Submodule Integrated DC-DC Converters (SubMICs)

Mismatched photovoltaic modules or systems exhibit nonconvex output power versus output voltage characteristics with multiple maxima that hinder operation of maximum power point (MPP) tracking algorithms and result in the need to operate photovoltaic system power electronics over a wider range of MPP voltages.

Many photovoltaic architectures based on distributed power electronics capable of module-level MPP tracking (MPPT) have been investigated, including DC-AC microinverters or DC-DC module-integrated converters (MICs). In these approaches, the impact of mismatches is reduced by performing module-level MPPT, at the expense of insertion losses and increased cost associated with the distributed power optimizers that are required to process full photovoltaic power even in the case when no mismatches are present.

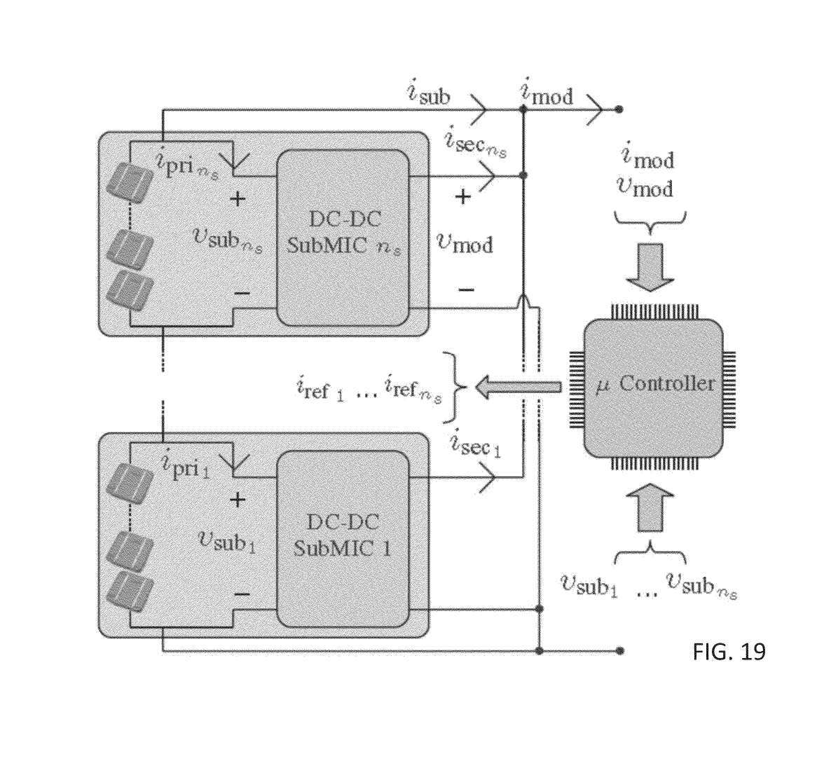

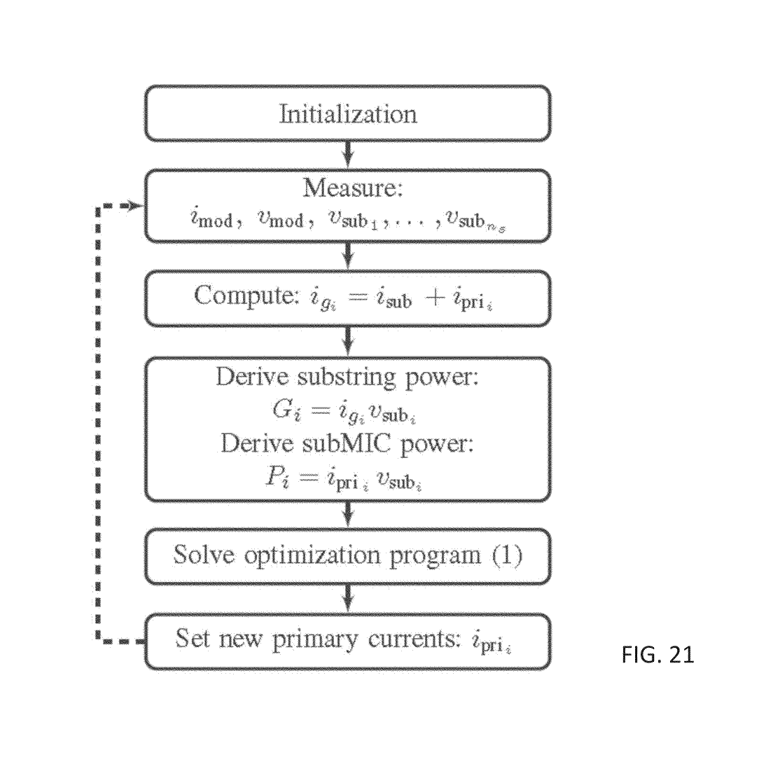

FIG. 19 shows an example implementation diagram in which a central controller and only one module-level current sensor, which could be the same current sensor used for MPP tracking by downstream power electronics (e.g., a microinverter supplied by the module), are used. A flowchart of an example control algorithm is shown in FIG. 21. A disadvantage of the approach shown in FIG. 19 is that the central controller must sense multiple voltages and issue multiple reference signals to the subMlCs.

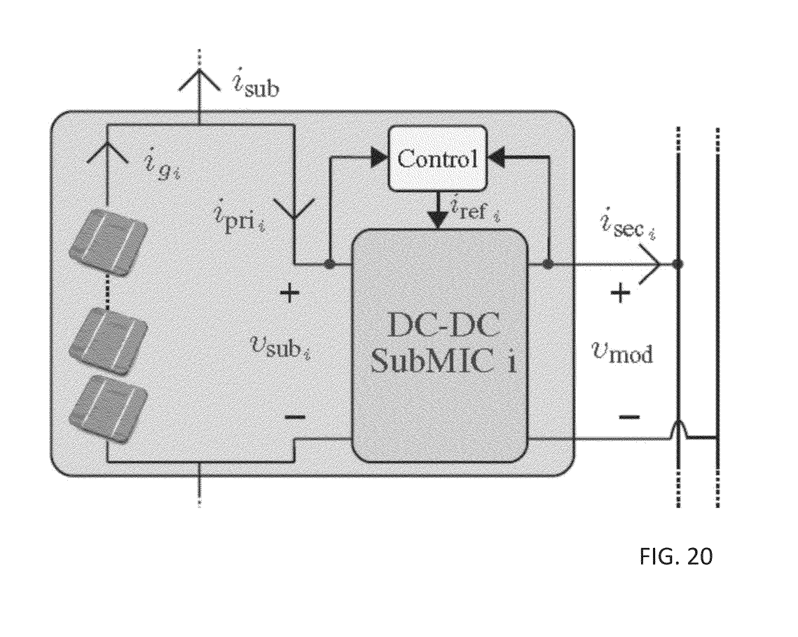

An alternative, distributed subMIC control approach that does not require a central controller is shown in FIG. 21. In this example implementation, each subMIC can be controlled independently from the others. In the discussion that follows, it is assumed that the subMIC-enhanced PV module is attached to a converter (e.g., a microinverter) that performs traditional MPP tracking using one of many available methods. The module output voltage is set to the MPP value v_{mod}=V_{d}. Assuming that substrings have an identical number of cells, power balance can be achieved by balancing substring voltages. Although the substring MPP voltage may change with operating conditions (such as irradiance and temperature), it is assumed in this example that such changes can be considered relatively small. FIG. 20 shows a substring and its corresponding subMIC that regulates the substring voltage to a reference proportional to the secondary port voltage v_{mod}.

A comparison between various SubMIC control schemes is disclosed in Olalla, C., Clement, D., Rodriguez, M. and Maksimovic, D., Architectures and Control of Submodule Integrated DC-DC Converters for Photovoltaic Applications, IEEE Trans. On Power Electronics, Vol. 28, No. 6, June 2013 pp. 2980-2997, which is incorporated herein by reference as if it were set forth in its entirety, and is also included in United States provisional patent application number 61785196, filed on March 14, 2013, which is also incorporated by reference in its entirety. As discussed therein, in practice, photovoltaic modules have a relatively small number of substrings and worst case solutions for the proposed control approach are much closer to the optimal. For a considered typical module with three substrings, in the worst case, the optimal solution corresponds to Pₒₚₜ=V_{ref} I_{g}, while the proposed distributed control approach yields P_{subopt}=4/3 V_{ref} I_{g}. In other words, the worst case power processed by the subMlCs using the simple, distributed control approach is 33% higher than the optimum.

In addition to the very simple distributed implementation, the proposed suboptimal control approach has another important advantage in that it allows subMlCs with lower power rating, since power is distributed following equations (18) and (19), so that subMIC power rating can be reduced to (ns −1)/ns of subMIC power rating with the optimal approach. In the considered typical PV module example with three substrings, the subMIC power rating is equal to 67% of the subMIC power rating required to implement the optimal solution.

The steady-state solution of the suboptimal control approach yields an important conclusion about its behavior. Since substring currents are balanced to an average value, the sum of primary/secondary subMIC currents is zero. This means that all power transferred to the secondary port of subMlCs is absorbed by the remaining subMlCs, and therefore, the secondary port average power is zero. This implies that the secondary port of the subMlCs can be disconnected from the module output, leading to an isolated-port architecture.

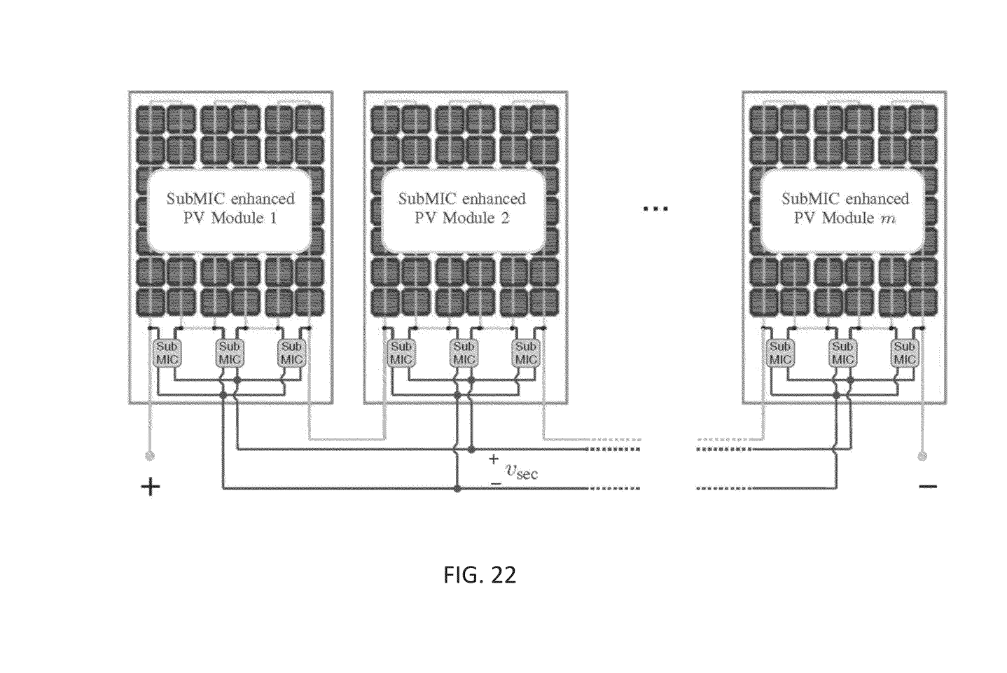

It should also be noted that the subMIC secondary port of a module can be connected in parallel with the subMIC secondary port of another module. In turn, such subMIC-enhanced modules with shared secondary ports can be connected in series to form larger PV arrays in much the same way traditional PV systems are realized, but with the advantage of built-in balancing (see FIG. 22). The extension of the isolated-port architecture to arbitrarily long chains of series-connected substrings or modules and to arbitrarily high dc voltages does not impact subMIC power or voltage rating, with an exception of the transformer dc isolation voltage rating. It is also worth noting that active filtering can be implemented with an energy storage capacitor on the subMIC isolated port, as shown in FIG. 16A, with potentials to reduce the cost and improve efficiency of downstream power electronics connected to the subMIC-enhanced module or a string of subMIC-enhanced modules.

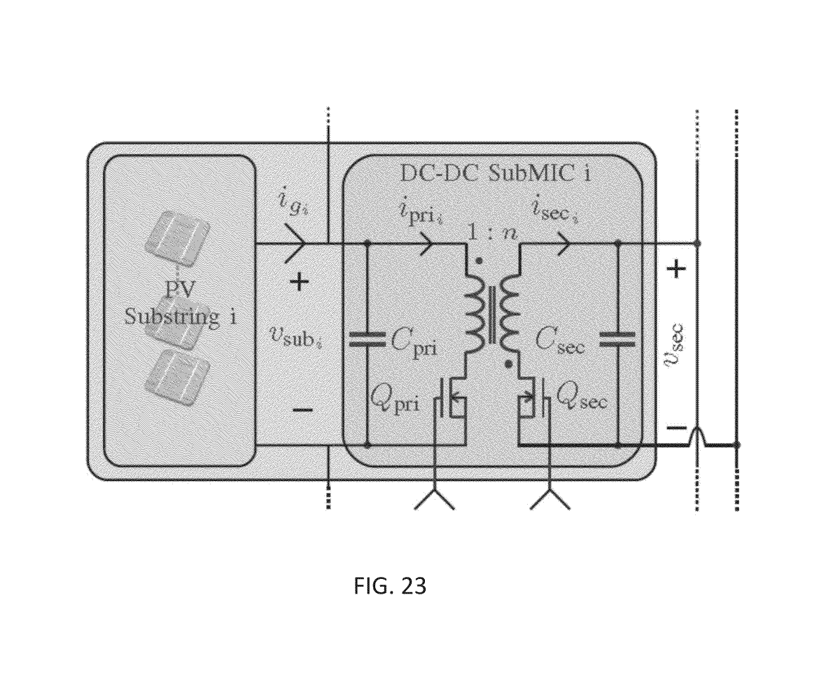

FIG. 23 shows an example implementation in which each subMIC is implemented as a bidirectional flyback converter. This topology provides isolation and bidirectional power transfer capabilities. Operation in DCM eliminates diode reverse recovery losses, thus allowing high efficiency. Furthermore, when the converter is operated in DCM, it exhibits simpler dynamic behavior, allowing a simpler controller design, as well as faster changes in the direction of power transfer.

In order to transfer power from primary to secondary side, Qₚᵣᵢ is controlled using a conventional, constant-frequency pulse-width modulation with a duty cycle D=(Tₒₙ/Tₛ), with Tₒₙ being a switch on time and Tₛ being the switching period. The secondary-side switch Q_{sec} remains OFF at all times, and its body diode acts as a flyback diode. To reverse the power transfer direction, the converter is operated in a completely symmetrical manner: Qpri remains OFF during the complete switching period, its body diode acts as the flyback diode, and Qsec is now controlled in the manner described previously. The flyback implementation of each subMIC includes capacitances both in the primary Cₚᵣᵢ and secondary side C_{sec}. Given that all subMlCs are ideally identical, the total secondary capacitance in the proposed architecture is C_{seq}=C_{sec}·nₛ. The primary-side magnetizing inductance Lₚᵣᵢ is chosen to maintain DCM under all operating conditions.

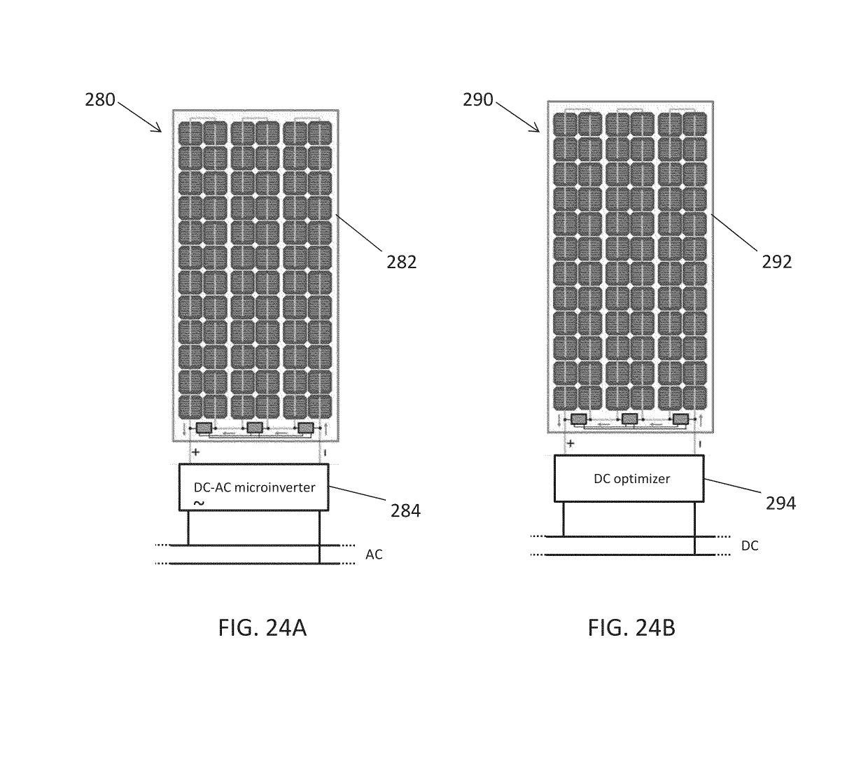

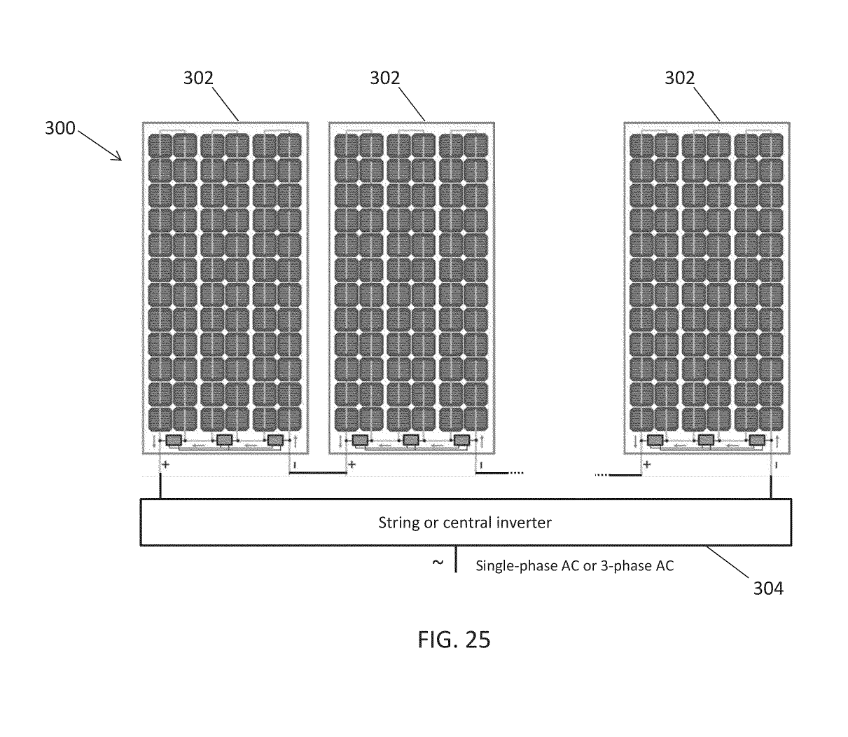

FIGS. 24A and 24B show example implementations of a photovoltaic systems 280, 290. In FIG. 24A, for example, the photovoltaic system 280 comprises a SubMIC-enhanced module 282 and a microinverter 284. The microinverter 284 can be a single-phase or three-phase microinverter. In FIG. 24B, however, the photovoltaic system 290 comprises a SubMIC-enhanced module 292 and a DC optimizer 294. The DC optimizer 294 output can be connected in series or parallel.

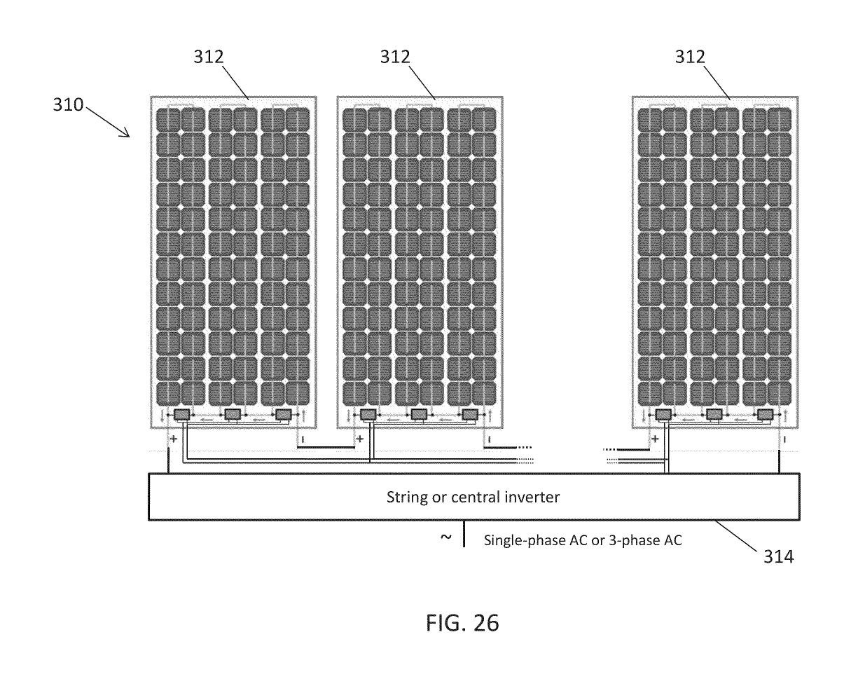

FIG. 26 shows a photovoltaic system 300 comprising a string of SubMIC-enhanced modules 302 and one or more string inverters or a central inverter 304. The inverter(s) can be single-phase or three-phase.

FIG. 27 shows a photovoltaic system 310 comprising a string of SubMIC-enhanced modules and one or more string inverters or a central inverter. The inverters can be single-phase or three-phase. In this implementation, an isolated secondary port is shared among the modules. The isolated secondary port can also be used to sense and report measurements or operational status of modules.

Although many implementations have been described above with a certain degree of particularity, those skilled in the art could make numerous alterations to the disclosed implementations without departing from the spirit or scope of this invention. For example, although many example implementations are provided in conjunction with photovoltaic cells and modules, the various implementations may be used in conjunction with any other type of electrochemical, electrical or electronic cell, such as, but not limited to, series-connected cells or substrings including systems based on battery cells, capacitors or super-capacitors, solid-state lighting (LED) systems, thermoelectric couples or other systems with electrical or electronic components or modules connected in series. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A balancing circuit comprising:
a plurality of primary ports;
an isolated secondary port; and
one or more DC-DC converters connected between the primary ports and the isolated secondary port, each DC-DC converter comprising at least one power switch,
the DC-DC converters configured to adjust a primary port current received at one or more of the plurality of primary ports based upon a difference between a voltage at the one of the primary ports and a reference voltage.

2. The balancing circuit of claim 1 wherein the reference voltage is derived from at least one of:
a secondary port voltage, and
a system output voltage of a series connected cell power system.

3. The balancing circuit of claim 1 wherein the balancing circuit comprises at least one controller configured to adjust the primary port current by adjusting a control input for at least one power switch in the one or more DC-DC converters.

4. The balancing circuit of claim 3 wherein the control input is at least one of (i) a duty cycle and (ii) a switching frequency.

5. The balancing circuit of claim 3 wherein the at least one controller is configured to adjust the control input for at least one power switch based on at least one of (i) the difference between the voltage at the first primary port and the reference voltage, and (ii) the input derived from the system output voltage.

6. The balancing circuit of claim 3 wherein the at least one controller is configured to adjust the control input for at least one power switch in proportion to the difference between the voltage at the one of the primary ports and the voltage at the isolated secondary port.

7. The balancing circuit of claim 1 wherein the primary port current of the DC-DC converter is proportional to the difference between a voltage at the one of the primary ports and a voltage at the isolated secondary port.

8. The balancing circuit of claim 1 wherein the isolated port comprises a monitoring signal.

9. The balancing circuit of claim 1 wherein the monitoring signal comprises at least one of a power indication, a temperature indication, a functionality indication, and a failure indication.

10. The balancing circuit of claim 1 wherein a filtering capacitor is connected across the isolated secondary port.

11. An electric power system comprising:
a plurality of cell substrings and a balancing circuit,
the cell substrings comprising one or more cells connected in series, and
the balancing circuit comprising a plurality of isolated DC-DC converters, the isolated DC-DC converters comprising:
at least one power switch,
a primary port connected in parallel with a photovoltaic cell substring, and
an isolated secondary port connected in parallel with isolated secondary ports of other isolated DC-DC converters.

12. The electric power system of claim 11 wherein the plurality of cell substrings comprises a plurality of photovoltaic cell substrings comprising one or more photovoltaic cells connected in series.

13. The electric power system of claim 12 wherein the balancing circuit is configured to receive a reference input derived from the system output voltage.

14. The electric power system of claim 13 wherein the balancing circuit comprises a controller configured to adjust a primary port current in response to a difference between a primary port voltage and the reference voltage.

15. The electric power system of claim 11 wherein the balancing circuit is configured to adjust a primary port current received at one or more of the plurality of primary ports based at least in part on a reference input derived from a voltage at the isolated secondary port.

16. The electric power system of claim 16 where the one or more cells comprise at least one of the following: a photovoltaic cell, an energy storage cell, a battery cell, a capacitor, a thermoelectric couple, an electronic device, or an electronic module.

17. The electric power system of claim 10 wherein the electric power system is configured to be coupled to an AC electric grid via at least one of a microinverter, a string inverter and a central inverter.

18. The electric power system of claim 10 wherein a filtering capacitor is connected across the isolated secondary port.

19. The electric power system of claim 10 wherein the balancing circuit is configured to the reference input is derived from the secondary port voltage

20. A method of balancing a plurality of electric cell substrings, the method comprising:
coupling a primary port of a first DC-DC converter in parallel with a first cell substring;
coupling a primary port of a second DC-DC converter in parallel with a second cell substring;
coupling an isolated secondary port of the first DC-DC converter in parallel with an isolated secondary port of the second DC-DC converter;
adjusting a primary port current received at at least one of the primary ports based upon a difference between a voltage at the one of the primary ports and a reference voltage.

21. The method of claim 20 wherein the plurality of electrical cell substrings comprise at least one cell selected from the group comprising: a photovoltaic cell, an energy storage cell, a battery cell, a capacitor, a thermoelectric couple, an electronic device, or an electronic module.

22. The method of claim 20 wherein the primary port current of the first DC-DC converter is proportional to a difference between a voltage at the one of the primary ports and a voltage at the isolated secondary port.

23. The method of claim 20 wherein each of the DC-DC converters comprises a controller configured controller configured to adjust the primary port current by adjusting a control input for at least one power switch in one or more of the first and second DC-DC converters.
